(19) United States
(12) Patent Application Publication
(10) Pub. No.: US 2018/0128963 A1
(43) Pub. Date: May 10, 2018

(54) METHOD FOR PRODUCING FUSED LIGHT GUIDE PANEL

(71) Applicant: Seung Ho HO, Seoul (KR)

(72) Inventor: Seung Ho HO, Seoul (KR)

(21) Appl. No.: 15/577,754

(22) PCT Filed: May 27, 2016
(86) PCT No.: PCT/KR2016/005661

§ 371 Date: Nov. 28, 2017

(30) Foreign Application Priority Data
May 28, 2015 (KR) 10-2015-0075122
Nov. 6, 2015 (KR) 10-2015-0155666

(51) Int. Cl. F21V 8/00; G02B 6/255; G02B 27/00

(52) U.S. Cl. CPC G02B 6/0076; G02B 6/255; G06F 17/50; G02B 27/0012; G02B 6/0091; G02B 6/0073

(57) ABSTRACT

The purpose of the present invention is to provide a method for producing a fused light guide panel which imparts free forms and three-dimensional and dynamic movements to various indoor and outdoor advertisements, signboards, promotional materials, public structures, displays, indicators, and the like by implementing a thin screen using only a single light guide panel base without using a separate screen panel or an auxiliary diffuser plate. The method for producing a fused light guide panel according to the present invention comprises: a step of manufacturing a planar or three-dimensional transparent light guide panel base by means of an optical PMMA resin; an optical design step of applying CAD and optical design to the upper and/or lower surfaces of the transparent light guide panel base; a step of converting each optically designed file into an output file; a step of sending the converted files to a printer and spraying colored and colorless light-guide ink on the upper and/or lower surfaces of the transparent light guide panel base to form multiple light guide printing layers via simultaneous and/or sequential multiple rounds of digital printing; and a step of producing a light guide panel by disposing an LED light source on the side of the transparent light guide panel base.

### TECHNICAL FIELD

The present invention relates to a fusion-type light guide panel. More particularly, the present invention relates to a method of manufacturing a fusion-type light guide panel capable of being utilized in various indoor and outdoor advertisements, signboards, promotional materials, public structures, displays, indicators, and the like, allowing light emission also in a pattern having a bent shape through optical design, providing free forms and stereoscopic and dynamic movements, and realizing permeability of a light guide ink, convenience of manufacture, customer's visual orientation, and the like according to use.

### BACKGROUND ART

A light guide panel (LGP), which is generally included in a backlight unit (BLU) of a liquid crystal display (LCD), is an optical component composed of a transparent synthetic resin such as polymethyl methacrylate (PMMA) that changes the path of light of a line consisting of a light source of a cold cathode fluorescent lamp (CCFL) or a light emitting diode (LED) or a point light source thereof to a plane light source.

Here, a light guide pattern is formed on a surface of the light guide panel such that the light guide panel uniformly transmits light emitted from a light source to an entire surface of an LCD panel.

Here, the light guide pattern may be a prism pattern, a checkerboard pattern, a polygonal pattern, a dot pattern, a bar pattern, or the like.

Recently, the production of environmentally friendly products capable of suppressing the use of environmentally harmful existing substances used as materials for a light source and minimizing power consumption by increasing luminous efficacy has been increased, and designs of display devices such as TVs have been slimmed down. Accordingly, an environmentally friendly and efficient LED tends to be applied as a light source of a backlight unit, and an edge-type backlight unit wherein an LED is disposed at ends of a light guide panel are being recognized as a suitable form for reasons of quality, design, economic efficiency, and the like instead of a direct-type backlight unit wherein many LEDs are arranged at a constant interval in a large area.

Accordingly, the importance of a light guide panel applied to an edge-type backlight unit is increasing.

However, currently, use of a light guide panel for TVs is rapidly increasing, but a production method of the LGP for TVs is not stabilized in the industrial field, resulting in a lot of defects in production. Accordingly, there is a phenomenon that supply does not meet demand.

An ideal light guide panel should be free from deformation even upon use of an LED generating heat as a light source due to high heat distortion temperature and surface hardness, and should be free of surface scratches that can easily occur upon handling of a large area light guide panel such as a TV.

In addition, an ideal light guide panel should have high productivity due to a simple process, should be manufactured at low cost, and should exhibit superior appearance quality, without shade or stain, even upon assembly into a backlight unit.

Meanwhile, a light guide panel is generally formed of a synthetic acrylic resin (polymethyl methacrylate, PMMA) providing superior transparency and weatherability, and PMMA used as a material of a light guide panel including a light guide pattern formed thereon can be obtained by polymerizing methyl methacrylate (MMA) as a liquid monomer.

Here, a polymerization method can be divided into a suspension polymerization method and a bulk polymerization method. The properties of PMMA are changed depending upon a polymerization method, whereby a method of forming a light guide pattern on a light guide panel formed of the PMMA is changed.

Suspension polymerization is performed in a state in which methyl methacrylate (MMA), which is a monomer, is dispersed into a particle size of about 0.01 mm to 1 mm in water, which is an inert medium. PMMA obtained as a result of such polymerization has a granular shape, thereby being advantageous for re-shaping by heat processing.

However, PMMA obtained by suspension polymerization has drawbacks such as a large thermal expansion coefficient and great deformation under pressure.

On the other hand, although bulk polymerization, as a radical polymerization method characterized by only applying a monomer or a small amount of initiator without a solvent or a dispersion medium, is disadvantageous in that it is difficult to remove heat while performing polymerization, the bulk polymerization allows obtainment of a high-quality light guide panel having high heat stability and surface hardness by providing high hardness and a low thermal expansion coefficient through optimization of a polymerization condition.

Using such bulk polymerization, a plate material is generally manufactured by a casting manufacturing method.

In addition, when suspension polymerization is used to manufacture a light guide panel having a light guide pattern formed thereon, flowable PMMA is injection-molded to manufacture a light guide panel, or a light guide panel material manufactured by an extrusion process is subjected to a separate cutting process and a light guide pattern processing process and then manufactured into a light guide panel.

On the other hand, when bulk polymerization is used, a PMMA light guide panel material is manufactured by a casting method wherein polymerization is performed using methyl methacrylate (MMA) as a raw material, and then subjected to a separate cutting process and a light guide pattern processing process as in the extrusion process, thereby being manufactured into a light guide panel.

A method of manufacturing a light guide panel including a light guide pattern formed thereon depends upon a method of forming a pattern on a transparent light guide panel material. As methods of forming a pattern on a light guide panel for TVs, there are printing, laser, and imprinting techniques. However, such conventional manufacturing methods have the following problems.

First, a method of manufacturing a light guide panel by a printing method, which is characterized by forming a pattern by cutting a transparent light guide panel material to fit the size of the light guide panel and then pushing a liquid ink to be printed into a hole portion of a mask material such as a silk screen, generally has the same principle as a mimeograph and uses a light guide panel material manufactured using an extrusion method using suspension polymerization and a light guide panel material manufactured using a casting method using bulk polymerization.

In the case of a light guide panel for a monitor of 32 inches or less, a printing method with good productivity is generally used.

However, in the case of a light guide panel for a large-area TV having a size of 32 inches or more, there is a problem that a pattern is not formed in a conventional monitor printing process.

In particular, it is difficult to uniformly apply a liquid substance to be printed to grooves of a mask due to a wide printing area and a small pattern size. When a light guide panel is produced by repeating this method, small patterns of a mask are clogged by an ink, whereby repetitive reproducibility is decreased and a great problem, such as a change in optical characteristics, occurs.

Generally, the problems are more frequent in a light guide panel of 40 inches or more.

In addition, there is a problem that deformation easily occurs in a process of thermally drying an ink.

When a light guide panel is manufactured using a laser technique, a transparent light guide panel material is cut to a size corresponding to the size of a light guide panel, and then patterned using a CO₂ laser advantageous for etching of a light guide panel material. Particularly, the light guide panel material is etched with the energy generated by the laser to form an engraved pattern.

This method is applicable to any PMMA light guide panel materials manufactured by suspension polymerization or bulk polymerization. However, since each pattern is etched and formed using a laser in the case of such a light guide panel manufacturing method using a laser technique, a manufacturing time is extended with increasing area, and economic efficiency is decreased due to high facility investment cost.

When a light guide panel is manufactured using an imprinting technique, a transparent light guide panel material is cut to a size corresponding to the size of a light guide panel and one side surface of the transparent light guide panel material is coated with a ultraviolet (UV) curable paint, is pressed by a separate plate or cylindrical roll having a pattern to form a pattern thereon, and is irradiated with ultraviolet (UV) to cure the pattern.

This method is applicable to any PMMA panels manufactured by suspension polymerization and bulk polymerization.

However, since this method has not yet been stabilized in producing a light guide panel having a size of, particularly, 40 inches or more, there are problems such as low productivity and yield.

An injection-molding technique is being used as a method of manufacturing a light guide panel having a size of about 20 inches or less although it is not used as a method of forming a pattern on a light guide panel for TVs.

In the case of an injection-molded light guide panel, a PMMA resin, which is prepared by suspension polymerization and dissolved by heat, is injected into a mold having a pattern formed thereon and is pressed, thereby manufacturing a light guide pattern and a light guide panel material.

This technique is preferred in that a process of cutting a light guide panel is not added and a process is simplified due to a light guide pattern simultaneously molded also on a light guide panel, but has the following problems.

There are difficulties in applying the injection-molding technique to a light guide panel having a size of 24 inches because an injection pressure of about 1 ton is necessary per 1 cm² of a light guide panel upon injection molding. In particular, application thereof is more difficult in a light guide panel of 32 inches or more for large-area TVs.

In addition, a light guide panel having an injection-molded light guide pattern formed thereon generally has a heat deflection temperature of 80° C. or less, thereby being easily deformed at high temperature.

Meanwhile, conventional methods such as a method of manufacturing a light guide panel using flowable PMMA by an injection molding process and a method of manufacturing a light guide panel by a separate light guide pattern processing process after manufacturing a PMMA light guide panel material by an extrusion method or a casting method have a high raw material cost and use of PMMA having poor supply as a raw material, as well as the aforementioned disadvantages.

Accordingly, with regard to production of a light guide panel having a light guide pattern formed thereon, if a light guide panel having a light guide pattern formed thereon, which is applicable to a light guide panel for LED TVs having a size greater than 30 inches and has superior quality characteristics than quality characteristics, such as surface hardness and heat deflection characteristics, of PMMA subjected to suspension polymerization without a separate subsequent process of forming a light guide pattern, can be produced, this can lead to innovative improvements in the light guide panel manufacturing industry.

That is, if a processing process of a light guide pattern can be omitted upon manufacture of a light guide panel having a light guide pattern formed thereon at a relatively high heat deflection temperature, a processing time, processing costs, logistics costs, and the like can be innovatively reduced.

### RELATED ART DOCUMENT

### Patent Document

Korean Patent Publication Application No. 10-2011-0134248 (published on Dec. 14, 2011)

### DISCLOSURE

### Technical Problem

Therefore, the present invention has been made in view of the above problems, and it is one object of the present invention to provide a method of manufacturing a fusion-type light guide panel capable of imparting free forms and stereoscopic and dynamic movements to various indoor and outdoor advertisements, signboards, promotional materials, public structures, displays, indicators by realizing a thin screen using only a single light guide panel base without use of a separate screen panel or an auxiliary diffuser plate.

### Technical Solution

In accordance with one aspect of the present invention, provided is a method of manufacturing a fusion-type light guide panel, the method including a step of manufacturing a planar or stereoscopic transparent light guide panel base 10 using an optical polymethyl methacrylate (PMMA) resin; an optical design step of performing optical computer-aided design (CAD) for an upper or lower surface of the planar or stereoscopic transparent light guide panel base 10; a step of converting an optically designed individual file into an output file; a step of sending the converted file to a printer and spraying a colored or colorless light-guide ink onto the planar or stereoscopic transparent light guide panel base 10 to form one printed light guide layer 20 or simultaneously form multiple printed light guide layers 20, through digital printing or multiple rounds of digital printing, on an upper or lower surface of the planar or stereoscopic transparent light guide panel base 10; and a step of installing LED light sources 30 at opposite sides of the planar or stereoscopic transparent light guide panel base 10 to manufacture a light guide panel P.

In accordance with another aspect of the present invention, provided a method of manufacturing a fusion-type light guide panel, the method including a step of manufacturing a planar or stereoscopic transparent light guide panel base 10 using an optical polymethyl methacrylate (PMMA) resin; an optical design step of performing optical computer-aided design (CAD) for an upper and/or lower surface of the planar or stereoscopic transparent light guide panel base 10; a step of converting an optically designed individual file into an output file; a step of sending the converted file to a printer and spraying a colored or colorless light-guide ink to an upper and/or lower surface of the planar or stereoscopic transparent light guide panel base 10 to form multiple printed light guide layers 20 through simultaneous and/or sequential multiple rounds of light-guide digital printing; and a step of installing LED light sources 30 at opposite sides of the planar or stereoscopic transparent light guide panel base 10 to manufacture a light guide panel P.

In accordance with yet another aspect of the present invention, provided is a method of manufacturing a fusion-type light guide panel, the method including a step of manufacturing a planar or stereoscopic transparent light guide panel base 10 using an optical polymethyl methacrylate (PMMA) resin; an optical design step of performing optical computer-aided design (CAD) for upper and lower surfaces of the planar or stereoscopic transparent light guide panel base 10; a step of converting an optically designed individual file into an output file; a step of sending the converted file to a printer and spraying a colored or colorless light-guide ink to upper and lower surfaces of the planar or stereoscopic transparent light guide panel base 10 to form multiple printed light guide layers 20 through simultaneous and/or sequential multiple rounds of light-guide digital printing; and a step of installing LED light sources 30 at opposite sides of the planar or stereoscopic transparent light guide panel base 10 to manufacture a light guide panel P.

### Advantageous Effects

As apparent from the fore-going, the present invention advantageously provides a method of manufacturing a fusion-type light guide panel characterized by manufacturing a planar or stereoscopic light guide panel base using an optical polymethyl methacrylate (PMMA) resin or various transparent or semitransparent light guide materials, precisely performing optical computer-aided design (CAD) for a free shape on an upper surface and/or a lower surface of the planar or stereoscopic light guide panel base such that light is transmitted through various curved or stereoscopic patterns in a desired manner, and spraying a light guide ink to the upper surface and/or the lower surface of the planar or stereoscopic light guide panel base to perform digital printing for the upper surface and/or the lower surface of the planar or stereoscopic light guide panel base, followed by installing light sources at both sides of the planar or stereoscopic light guide panel base. Accordingly, the method of manufacturing a fusion-type light guide panel is capable of being utilized in various indoor and outdoor advertisements, signboards, promotional materials, public structures, displays, indicators, and the like, allowing light emission also in a pattern having a bent shape through optical design, providing free forms and stereoscopic and dynamic movements, and realizing permeability of a light guide ink, convenience of manufacture, customer's visual orientation, and the like according to use.

In particular, the present invention has the following characteristics.

First, the optical computer-aided design of the present invention may accomplish brightness control, design of a reflective ink, stereoscopic design, and fusion-type design wherein colors are varied, due to various cell structures.

Second, in the present invention, various materials for light guiding may be digitally printed (flat or stereoscopic type, a 3D printed product, a single surface, both surfaces, a stereoscopic type, or the like) with a UV ink or a quick-drying ink (a colored, colorless, or reflective ink) and may be coupled with a separate image plate.

Third, in the present invention, all of idle portions, except for lamp positions at side parts, may be coated or tacked with a reflective or colored material or may be coupled with a colored molding for light transmission.

Fourth, the present invention may freely change a color of a light-guiding light of a light guide object.

Fifth, in the present invention, an end of the light guide panel base is thickly manufactured to irradiate a thin plate with a lot of light.

Sixth, in the present invention, a fusion-type light guide object (plate), to which bending and cutting are freely applied, may be driven by a mechanical or electric device or wind.

That is, as needed, a driving device, such as an electric motor or a magnet, is installed such that the screen plate freely moves, or a spring plate, a spring pin, a flexible plate, or the like is applied such that the fusion-type light guide panel P automatically moves due to wind.

Seventh, the present invention may be realized as a convenient fusion-type device manufactured by coupling the light guide panel base with an outline cutting system configured to cut an outline after digital printing.

Eighth, in the present invention, an instant-curing light guide object is manufactured using a 3D printer and a fusion-type device coupled with a 3D color printer may be realized.

Ninth, the present invention may be combined with various power generation devices and batteries where there is no electricity supply.

Tenth, the light guide panel base of the present invention may be mixed with acryl, polycarbonate, and various transparent or semitransparent materials, a fiber optic fabric, and the like, thereby manufacturing a light guide cloth.

Eleventh, the present invention may be widely utilized in various light guide objects, indoor and outdoor advertisements, signboards, promotional materials, public structures, displays, monitors, indicators and the like.

That is, the present invention may be utilized in displays, indicators, and the like, allow light emission according to optical design also in a pattern having a bent shape through optical design, and provide free forms and stereoscopic and dynamic movement.

Twelfth, a product having a predetermined compressed optical pattern including an existing light guide panel base may be manufactured into a product having a light-adjustable pattern into a desired size by compression, extrusion, or injection-molding or by means of a pattern roller or the like

Thirteenth, in the present invention, an instantly-curing light guide object is manufactured using a 3D printer and a fusion-type device coupled with a 3D color printer may be realized.

### DESCRIPTION OF DRAWINGS

FIG. 1 is an Exemplary View 1 of a fusion-type light guide panel assembly having a printed light guide layer on one surface thereof according to the present invention.

FIG. 2 is an Exemplary View 1 of a fusion-type light guide panel assembly having a printed light guide layer formed on both surfaces thereof according to the present invention.

FIG. 3 is an Exemplary View 2 of a fusion-type light guide panel assembly having a printed light guide layer formed on both surfaces thereof according to the present invention.

FIG. 4 is an Exemplary View 3 of a fusion-type light guide panel assembly having a printed light guide layer formed on both surfaces thereof according to the present invention.

FIG. 5 is an Exemplary View 4 of a fusion-type light guide panel assembly having a printed light guide layer formed on both surfaces thereof according to the present invention.

FIG. 6 is an Exemplary View 5 of a fusion-type light guide panel assembly having a printed light guide layer formed on both surfaces thereof according to the present invention.

FIG. 7 is an Exemplary View 1 of a fusion-type stereoscopic light guide panel according to the present invention.

FIG. 8 is an Exemplary View 2 of a fusion-type stereoscopic light guide panel according to the present invention.

FIG. 9 is an Exemplary View 3 of a fusion-type stereoscopic light guide panel according to the present invention.

FIG. 10 is an exemplary view illustrating a printed stereoscopic cross section of a fusion-type stereoscopic light guide panel according to the present invention.

FIG. 11 is an exemplary view illustrating both printed stereoscopic surfaces of a fusion-type stereoscopic light guide panel according to the present invention.

FIG. 12 is an exemplary view illustrating a stereoscopic light guide object according to the present invention.

FIG. 13 is an exemplary view illustrating a moving light guide object according to the present invention.

### BEST MODE

Hereinafter, the present invention is described in detail with reference to the accompanying drawings.

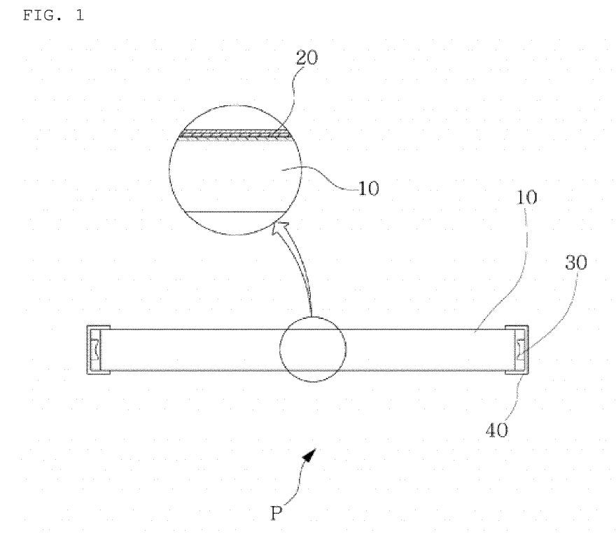

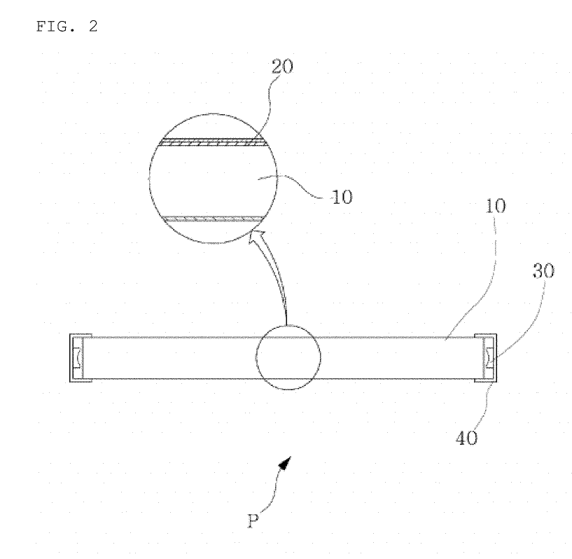

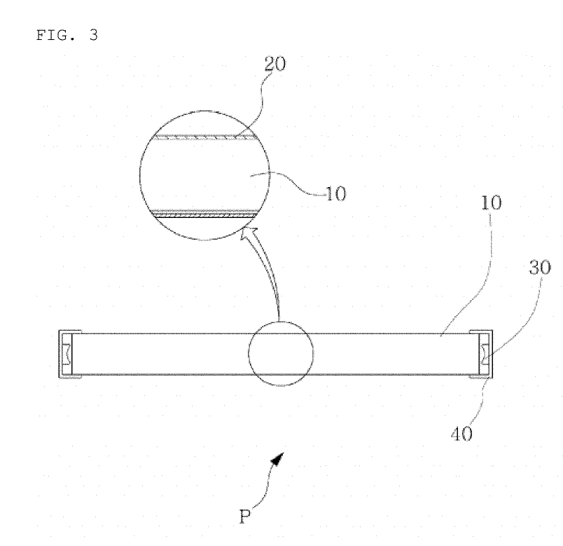

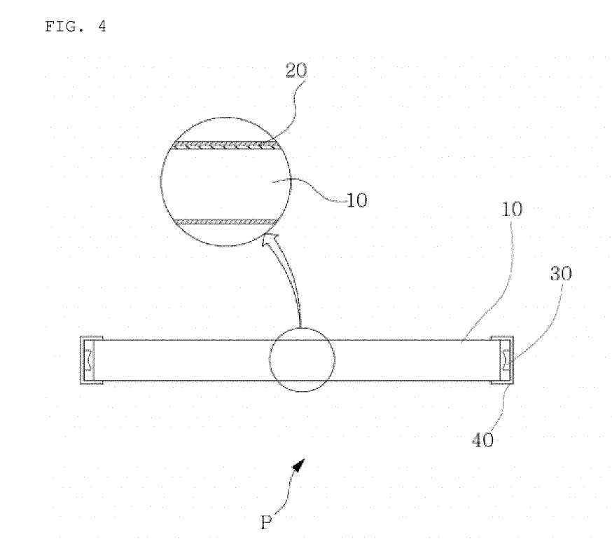

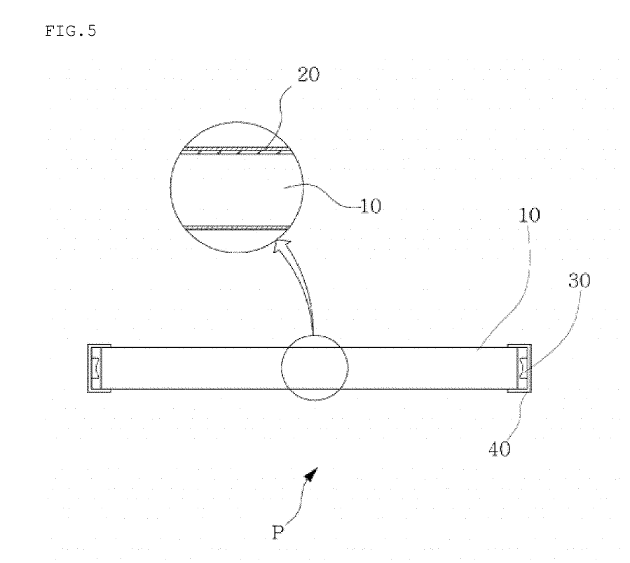

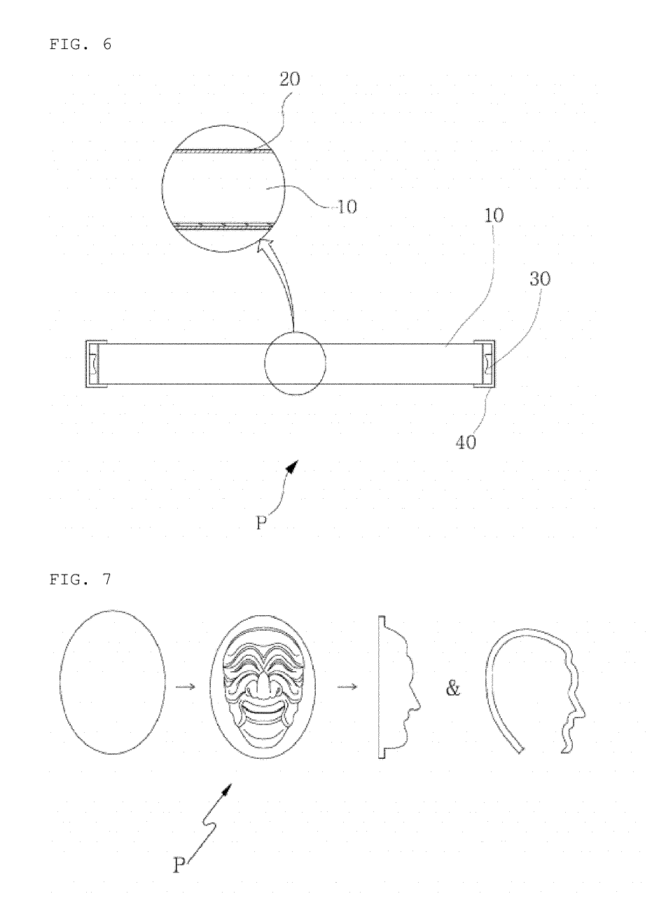

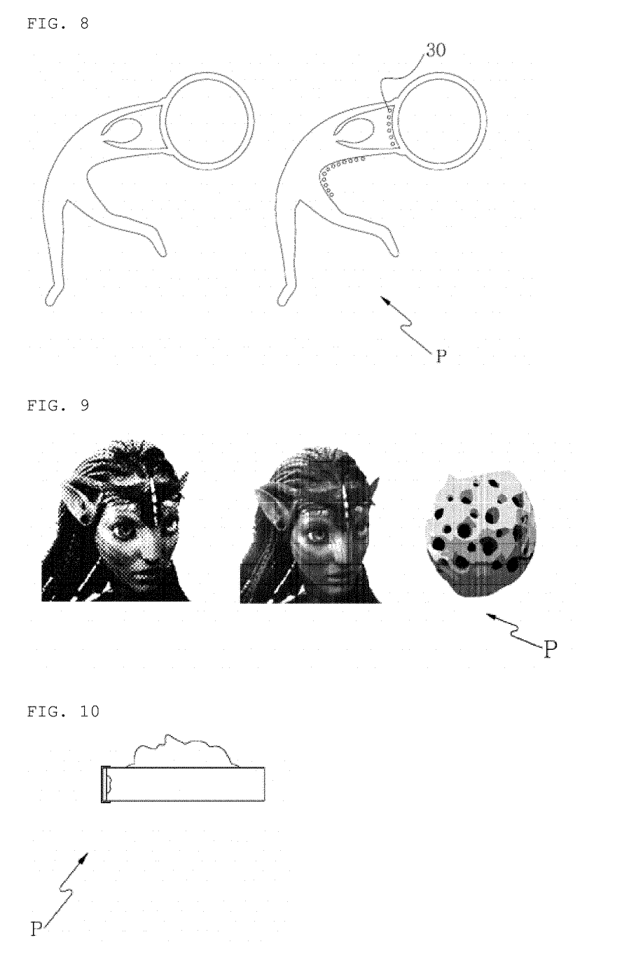

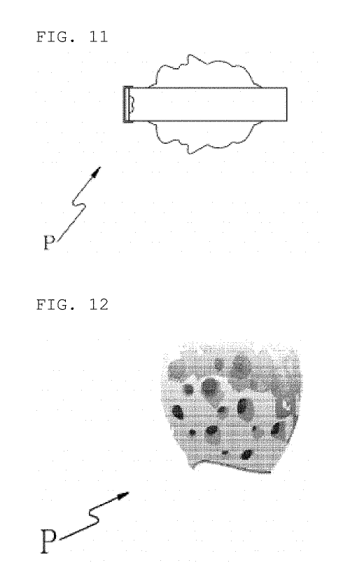

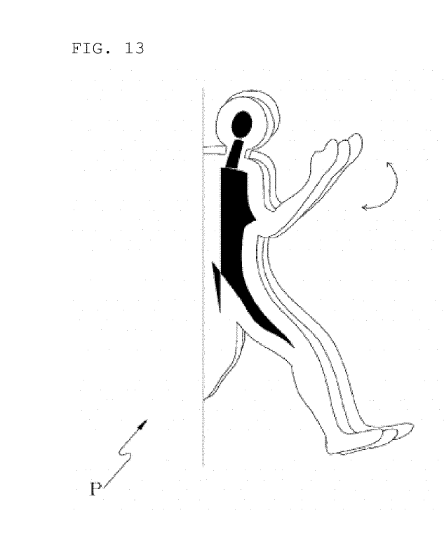

FIG. 1 is an Exemplary View 1 of a fusion-type light guide panel assembly having a printed light guide layer on one surface thereof according to the present invention, FIG. 2 is an Exemplary View 1 of a fusion-type light guide panel assembly having a printed light guide layer formed on both surfaces thereof according to the present invention, FIG. 3 is an Exemplary View 2 of a fusion-type light guide panel assembly having a printed light guide layer formed on both surfaces thereof according to the present invention, FIG. 4 is an Exemplary View 3 of a fusion-type light guide panel assembly having a printed light guide layer formed on both surfaces thereof according to the present invention, FIG. 5 is an Exemplary View 4 of a fusion-type light guide panel assembly having a printed light guide layer formed on both surfaces thereof according to the present invention, and FIG. 6 is an Exemplary View 5 of a fusion-type light guide panel assembly having a printed light guide layer formed on both surfaces thereof according to the present invention.

As illustrated in the drawings, the method of manufacturing a fusion-type light guide panel according to the present invention includes a step of manufacturing a planar or stereoscopic transparent light guide panel base 10 using an optical polymethyl methacrylate (PMMA) resin or various transparent or semitransparent materials; an optical design step of precisely performing optical computer-aided design (CAD) for optically designed various images, a single layer, a laminate, a stereoscopic layer, a 3D layer, a figure, and the like on an upper or lower surface of the planar or stereoscopic transparent light guide panel base 10 such that light is directly transmitted through various curved or stereoscopic patterns on a surface of the planar or stereoscopic transparent light guide panel base 10 in a desired manner; a step of converting an optically designed individual file into an output file; a step of sending the converted file to a printer and spraying a colored or colorless light-guide ink onto the upper or lower surface of the planar or stereoscopic transparent light guide panel base 10 to form one printed light guide layer 20 or simultaneously form multiple printed light guide layers 20, through direct digital printing or multiple rounds of simultaneously-performed digital printing, on an upper or lower surface of the planar or stereoscopic transparent light guide panel base 10; and a step of installing LED light sources 30 at opposite sides of the planar or stereoscopic transparent light guide panel base 10 to manufacture a light guide panel P.

In addition, the method of manufacturing a fusion-type light guide panel according to the present invention includes a step of manufacturing a planar or stereoscopic transparent light guide panel base 10 using an optical polymethyl methacrylate (PMMA) resin or various transparent or semitransparent light guide materials; an optical design step of precisely performing optical computer-aided design (CAD) for various images, a single layer, a laminate, a stereoscopic layer, a 3D layer, a figure, and the like on an upper surface and/or a lower surface of the planar or stereoscopic transparent light guide panel base 10 such that light is directly transmitted through various curved or stereoscopic patterns on an upper or lower surface of the planar or stereoscopic transparent light guide panel base 10 in a desired manner; a step of converting an optically designed individual file into an output file; a step of sending the converted file to a printer and spraying a colored or colorless light-guide ink onto the upper surface and the lower surface of the planar or stereoscopic transparent light guide panel base 10 to form one printed light guide layer 20 or to simultaneously form multiple printed light guide layers 20, through direct digital printing or multiple rounds of simultaneously-performed digital printing, on the planar or stereoscopic transparent light guide panel base 10; and a step of installing LED light sources 30 at opposite sides of the planar or stereoscopic transparent light guide panel base 10 to manufacture a light guide panel P.

In addition, the method of manufacturing a fusion-type light guide panel according to the present invention includes a step of manufacturing a planar or stereoscopic transparent light guide panel base 10 using an optical polymethyl methacrylate (PMMA) resin; an optical design step of precisely performing optical computer-aided design (CAD) for a photograph type, a gradation type, and the like on an upper surface and a lower surface of the planar or stereoscopic transparent light guide panel base 10 such that light directly transmits various curved or stereoscopic patterns on an upper or lower surface of the planar or stereoscopic transparent light guide panel base 10 in a desired manner; a step of converting an optically designed individual file into an output file; a step of sending the converted file to a printer and spraying a colored or colorless light-guide ink to the upper surface and the lower surface of the planar or stereoscopic transparent light guide panel base 10 to form one printed light guide layer 20 or simultaneously form multiple printed light guide layers 20, through direct digital printing or multiple rounds of digital printing simultaneously performed, on the planar or stereoscopic transparent light guide panel base 10; and a step of installing LED light sources 30 at opposite sides of the planar or stereoscopic transparent light guide panel base 10 to manufacture a light guide panel P.

The method further includes a step of cutting the light guide panel P, along with the printed light guide layer 20 formed on a surface of the planar or stereoscopic transparent light guide panel base 10, into a predetermined shape after manufacturing the light guide panel P.

A silver, white, or colored ink is printed on the planar or stereoscopic transparent light guide panel base 10 to control reflection or retroreflection of the light guide panel P and a screen illumination amount.

The LED light sources 30 have a vertically, horizontally, or freely curved shape.

The light guide panel P is freely curved up and down and right and left along a curve, and the LED light sources 30 and heat sinks are installed at ends of the light guide panel P.

As needed, ends of the planar or stereoscopic transparent light guide panel base 10 are formed thick to irradiate a lot of light.

A reflective material is spread between the LED light sources 30.

The ends of the light guide panel P have a predetermined groove shape.

The method of manufacturing a fusion-type light guide panel according to the present invention includes a step of manufacturing a planar or stereoscopic transparent light guide panel base 10 using an optical polymethylmethacrylate (PMMA) resin; a step of precisely performing optical computer-aided design (CAD) for various images, a single layer, a laminate, a stereoscopic layer, a 3D layer, a figure, and the like on an upper surface of the planar or stereoscopic transparent light guide panel base 10 without use of a separate diffuser plate or screen plate; a step of spraying a light guide ink onto the planar or stereoscopic transparent light guide panel base 10 and performing direct digital printing for the planar or stereoscopic transparent light guide panel base 10 to form the printed light guide layer 20; and a step of installing LED light sources 30 at opposite sides of the planar or stereoscopic transparent light guide panel base 10 to manufacture a light guide panel P.

After performing optical computer-aided design (CAD) for a lower surface of the planar or stereoscopic transparent light guide panel base 10, a light guide ink is sprayed onto the lower surface of the planar or stereoscopic transparent light guide panel base 10 to digitally print a white, colored, or colorless layer on the lower surface of the planar or stereoscopic transparent light guide panel base 10. Accordingly, the printed light guide layer 20 is formed and thus brightness of light is adjusted.

After performing optical computer-aided design (CAD) of the lower surface of the planar or stereoscopic transparent light guide panel base 10, a light guide ink is sprayed onto the lower surface of the planar or stereoscopic transparent light guide panel base 10 to form a printed light guide layer 20 having a reflective color, thereby adjusting an illumination amount of shade.

That is, the method of manufacturing a fusion-type light guide panel according to the present invention includes a computer-based optical design process and a production process of a digitally printed product.

In the computer-based optical design process, necessary various images, figures, and the like are optically designed. Subsequently, an optically designed screen to be applied to the planar or stereoscopic transparent light guide panel base 10 is sequentially designed (a single layer, a laminate, a stereoscopic layer, a 3D layer, and the like), a light guide screen is separated into a colored, colorless, or white or desired light color, and designed layers are separated in order, edited in order, and input into a designated digital printing program.

In addition, in the production process of a digitally printed product, the planar or stereoscopic transparent light guide panel base 10 is equipped with a device for direct digital printing, various images, figures, and the like are converted into output files according to program input, the images, the figures, and the like are digitally printed in an arranged order, and a digitally printed light guide panel P is cut and processed in a desired shape.

Here, in the computer-based optical design process, an existing three to four-step structure is omitted, an illumination amount of shade is adjusted to directly realize various light guide screens on the planar or stereoscopic transparent light guide panel base 10, and optical design of a cross section is variously, appropriately performed such that a desired shape is applied to a single layer, a laminate, a stereoscopic layer, a 3D layer, an image, a photograph, a plant or animal pattern, a morphological pattern such as a free circle, or an outer shape such as a free curve or a bend.

In addition, in the manufacturing process, an existing three to four-step structure is omitted, and partial reflection blocking is adjusted by digital printing for partially blocking reflection while realizing various light guide screens, optically designed data, and the like as a single layer, a laminate, a stereoscopic layer, a 3D layer using an ink on the planar or stereoscopic transparent light guide panel base 10 by direct digital printing.

Both surface of the planar or stereoscopic transparent light guide panel base 10 are manufactured to be seen by stepwise single-layer or multi-layer digital printing, light guide printing is applied to the both surfaces, and a cutting system of appropriately cutting an image, a photograph, a plant or animal pattern, a morphological pattern such as a free circle, or an outer shape such as a free curve or a bend is applied.

To provide uniform optical screen adjustment, a system for adjust partial blocking and retroreflection (reflective ink) is applied.

The light guide panel P may variously realize morphological patterns, outer shapes such as a free curve and a bend, and the like.

When a signboard or an advertising sign is applied to the light guide panel, a light guide object including the light guide panel moves due to wind or an electric driving device.

The LED light sources 30 perform freely curved full-color LED light control and dimming.

The free curve-type light guide panel P is freely applied while bending along a curve.

To eliminate bonding of a back reflective film in a light guide panel (P) of an existing product, a fusion-type digital printing device may be equipped with a separate head for applying a single color to simultaneously perform digital printing of a reflective ink.

A product having a predetermined compressed optical pattern including an existing light guide panel base 10 may be manufactured into a product having a light-adjustable pattern of a desired size by compression, extrusion, or injection-molding or by means of a pattern roller or the like.

Since the LED light sources 30 are arranged along a freely curved line, the corresponding heat sinks may also move freely.

Since a space between the LED light sources 30 and the LED light sources 30 is coated with a reflective material, luminous efficacy may be increased.

A cutting system configured to freely cut an outer shape of the light guide panel P after digital printing may be included.

The method of manufacturing a fusion-type light guide panel including the aforementioned configurations is characterized by manufacturing the planar or stereoscopic light guide panel base 10 using an optical polymethyl methacrylate (PMMA) resin, precisely performing optical computer-aided design (CAD) for a free shape on one surface or both surfaces of the planar or stereoscopic light guide panel base 10 such that light is transmitted through various curved or stereoscopic patterns in a desired manner, and spraying a light guide ink to the planar or stereoscopic light guide panel base 10 to form the printed light guide layers 20 on the planar or stereoscopic light guide panel base by digital printing, followed by installing the light sources 30 at opposite sides of the planar or stereoscopic light guide panel base 10. Accordingly, the method of manufacturing a fusion-type light guide panel is capable of being utilized in various indoor and outdoor advertisements, signboards, promotional materials, public structures, displays, indicators, and the like, allowing light emission also in a pattern having a bent shape through optical design, providing free forms and stereoscopic movement, and realizing permeability of a light guide ink, convenience of manufacture, customer's visual orientation, and the like according to use.

### MODE FOR CARRYING OUT THE INVENTION

Here, the method of manufacturing a fusion-type light guide panel according to the present invention is characterized by realizing various free shapes, a stereoscopic form, a bend, and the like of a desired transparent light guide panel base 10 on a screen surface of a light guide panel after illumination projection, and digitally printing a light guide ink on the light guide panel base 10, after designing light at a bright portion to be reduced and making a light guide design to be applied to free forms, to form a printed light guide layer 20. In particular, various light guide panel bases 10 are directly, digitally printed with a light guide ink such that an optical design is formed and freely expressed on the light guide panel base 10 according to a desired free form.

In addition, an optical design may be freely expressed on the light guide panel base 10.

Meanwhile, a cutting device configured to cut the digitally printed product or a formed pattern and the light guide panel base 10 in the same device may be applied.

In addition, lighting can be controlled from a single color to full color.

In addition, a stereoscopic light guide panel base 10 is formed by laminating a light guide ink. In addition, the light guide panel base 10 may be stereoscopically molded, and a 3D printed product for light guiding and a molded article may be provided.

Meanwhile, when a thin plate is utilized as the light guide panel base 10, a surface (an end portion of a material), where an LED is projected, of the LED light sources 30 is thickly formed such that a lot of light is irradiated thereto. That is, a [symbol] -shaped material to maximize efficiency may be developed and applied. When a light is partially used, light may be projected in a free form from any positions, such as an engraved part, an embossed part, a round interior, and a corner bend, depending upon a pattern. As needed, a driving device such as an electric motor, a magnet, or the like is installed such that a screen panel freely moves, or a spring plate, a spring pin, a flexible plate, or the like is applied such that a fusion-type light guide panel P automatically moves due to wind. When a plurality of thin plates is bonded, each of protruded [symbol] to [symbol] -shaped plates is applied to one molded flame and a reflector is disposed inside a molded light guide panel connection flame, whereby luminous efficacy may be increased and several types of frames/molding assistance plates may be coupled together. Fixing parts such as walls, supports, and the like may be fixed with prefabricated sockets. A reflector is formed between lamps used as LED light sources, thereby increasing luminous efficacy. A reflector may also be formed inside a molded product, thereby increasing luminous efficacy.

Meanwhile, a pattern of the light guide panel base is only carved, and a remaining part thereof may be stereoscopically formed without any pattern. The light guide panel base 10 may be combined with a product manufactured by an existing v-cutting method or an extrusion method or by means of a molding device.

In particular, when electricity is not supplied, a technology of using sunlight, a solar cell, a wind power generator, a battery, a hydrogen battery, or a reflective/phosphorescent material may be applied.

In particular, when electricity is not supplied, a technology of using sunlight, a solar cell, a wind power generator, a battery, a hydrogen battery, or a reflective/phosphorescent material may be applied.

While this invention has been particularly shown and described with reference to preferred embodiments thereof, it will be understood by those skilled in the art that various changes in form and detail may be made therein without departing from the spirit and scope of the invention as defined by the appended claims. The preferred embodiments should be considered in a descriptive sense only and not for purposes of limitation.

### DESCRIPTION OF SYMBOLS

10: Light guide panel base
20: Printed light guide layer
30: LED light source
40: Socket
P: Light guide panel

1. A method of manufacturing a fusion-type light guide panel, the method comprising:
a step of manufacturing a planar or stereoscopic transparent light guide panel base (10) using an optical polymethyl methacrylate (PMMA) resin;
an optical design step of performing optical computer-aided design (CAD) for an upper or lower surface of the planar or stereoscopic transparent light guide panel base (10);
a step of converting an optically designed individual file into an output file;
a step of sending the converted file to a printer and spraying a colored or colorless light-guide ink onto the planar or stereoscopic transparent light guide panel base (10) to form one printed light guide layer (20) or simultaneously form multiple printed light guide layers (20), through digital printing or multiple rounds of digital printing, on an upper or lower surface of the planar or stereoscopic transparent light guide panel base (10); and
a step of installing LED light sources (30) at opposite sides of the planar or stereoscopic transparent light guide panel base (10) to manufacture a light guide panel P.

2. A method of manufacturing a fusion-type light guide panel, the method comprising:
a step of manufacturing a planar or stereoscopic transparent light guide panel base (10) using an optical polymethyl methacrylate (PMMA) resin;
an optical design step of performing optical computer-aided design (CAD) for an upper and/or lower surface of the planar or stereoscopic transparent light guide panel base 10;
a step of converting an optically designed individual file into an output file;
a step of sending the converted file to a printer and spraying a colored or colorless light-guide ink to an upper and/or lower surface of the planar or stereoscopic transparent light guide panel base (10) to form multiple printed light guide layers (20) through simultaneous and/or sequential multiple rounds of light-guide digital printing; and
a step of installing LED light sources (30) at both sides of the planar or stereoscopic transparent light guide panel base (10) to manufacture a light guide panel P.

3. A method of manufacturing a fusion-type light guide panel, the method comprising:
a step of manufacturing a planar or stereoscopic transparent light guide panel base (10) using an optical polymethyl methacrylate (PMMA) resin;
an optical design step of performing optical computer-aided design (CAD) for upper and lower surfaces of the planar or stereoscopic transparent light guide panel base (10);
a step of converting an optically designed individual file into an output file;
a step of sending the converted file to a printer and spraying a colored or colorless light-guide ink to upper and lower surfaces of the planar or stereoscopic transparent light guide panel base (10) to form multiple printed light guide layers (20) through simultaneous and/or sequential multiple rounds of light-guide digital printing; and
a step of installing LED light sources (30) at both sides of the planar or stereoscopic transparent light guide panel base (10) to manufacture a light guide panel P.

4. The method according to any one of claims 1 to 3, wherein a silver, white, or colored ink is printed on the planar or stereoscopic transparent light guide panel base 10 to control reflection or retroreflection of the light guide panel P and a screen illumination amount.

5. The method according to any one of claims 1 to 3, wherein the LED light sources (30) have a free curve shape and a reflective material is spread between the LED light sources (30).

6. The method according to any one of claims 1 to 3, wherein the light guide panel P is freely applied while bending along a curve and the LED light sources (30) and heat sinks are installed at ends of the light guide panel P.

7. The method according to any one of claims 1 to 3, wherein, after manufacturing the light guide panel P, the light guide panel P with the printed light guide layer or layers (20) formed on the light guide panel P is cut into a predetermined shape.

8. The method according to claim 7, wherein the light guide panel P cut along with the printed light guide layer is attached to a wall via any one of a spring plate, a spring pin, and a flexible plate such that the light guide panel P is moved due to wind, is operated by an electric driving device, or is implemented such that an LED image is directly projected onto and displayed on the light guide panel P, or all idle portions of the light guide panel P are spread with a reflective or colored material or are coupled with a colored molding for illumination transmission.

9. The method according to any one of claims 1 to 3, wherein an optically designed pattern, light intensity of which is adjusted, is formed on the planar or stereoscopic transparent light guide panel base (10) through compression or extrusion or by means of a roller.

10. The method according to any one of claims 1 to 3, wherein the light guide panel P is manufactured by means of a 3D printer.

11. The method according to any one of claims 1 to 3, wherein ends of the planar or stereoscopic transparent light guide panel base (10) are formed thick to irradiate a lot of light.
